(19) United States
(12) Patent Application Publication
(10) Pub. No.: US 2010/0119710 A1
(43) Pub. Date: May 13, 2010

(54) Patterning apparatus and method using dip-pen nanolithography

(75) Inventors: Seung Hun Hong, Seoul (KR); Tae Yun Lee, Seoul (KR); Jong Han Oh, Suwon-Si (KR); Moon Gyu Sung, Seoul (KR); Dong Min Kim, Suwon-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 12/585,873

(22) Filed: Sep. 28, 2009

(30) Foreign Application Priority Data
Oct. 20, 2008 (KR) 10-2008-0102616

(51) Int. Cl. B05D 5/00; B05C 11/00

(52) U.S. Cl. 427/256; 118/667

(57) ABSTRACT

An apparatus and a method according to example embodiments is capable of patterning ink on a substrate by using dip-pen nanolithography regardless of the interaction between the ink and the substrate. The patterning apparatus may includes a heat supply control device. The heat supply control device may supply heat so as to liquefy the ink and facilitate the patterning of the ink on the substrate. The melting point of the ink may be set within the predetermined temperature controlled by the heat supply control device.

### CROSS-REFERENCE TO RELATED APPLICATION

This application claims priority under 35 U.S.C. §119 to Korean Patent Application No. 10-2008-0102616, filed on Oct. 20, 2008 with the Korean Intellectual Property Office, the entire disclosure of which is incorporated herein by reference.

### BACKGROUND

1. Field

The disclosure relates to dip-pen nanolithography (DPN) and the use thereof in connection with an apparatus and a method for patterning a metal material on a nonconductive substrate.

2. Description of the Related Art

Dip-pen nanolithography (DPN) is a technology for directly depositing various types of molecules on a surface of an object using an atomic force microscope (AFM) tip. According to the dip-pen nanolithography, a tip serving as a pen absorbs various types of molecular inks and drops the molecular inks on a substrate serving as a paper to form a pattern. As the tip makes contact with the substrate, a capillary tube is formed between the tip and the substrate, and the inks absorbed on the tip are diffused onto the substrate through the capillary tube.

The inks in the tip are absorbed onto the substrate through a chemical reaction or a relatively strong interaction between the inks and the substrate. Stated more clearly, the inks are absorbed onto the substrate through surface induction reduction reaction or coulombic interaction between the inks and the substrate such that a pattern is formed on the substrate.

When a relatively strong interaction that causes absorption does not occur between the inks and the substrate, the pattern may not be formed on the substrate through the dip-pen nanolithography process. Stated more clearly, if a bonding force between the ink and the substrate is smaller than a bonding force between the ink and the tip, then the pattern may not be formed on the substrate, because the ink is more inclined to remain on the tip as opposed to being transferred onto the substrate.

### SUMMARY

A patterning apparatus and patterning method according to example embodiments uses a dip-pen nanolithography process and is capable of forming a pattern on a substrate even if relatively little interaction exists between the inks and the substrate. Additional aspects and/or advantages of the disclosure will be set forth in part in the description which follows and, in part, will be apparent from the description, or may be learned by practice of the disclosure.

A patterning apparatus utilizing dip-pen nanolithography may include a substrate; a tip configured to be arranged in proximity or in contact with the substrate; an ink covering the tip, the ink being formed of a material having a liquid state; and a heat supply control device configured to convert the ink into the liquid state so as to facilitate a transfer of the ink onto the substrate by capillary action.

The heat supply control device may control a temperature of the ink to a level of a melting point of the ink. The heat supply control device may be connected with the tip to control the temperature of the tip to be lower than a melting point of the ink by a predetermined value. The ink may be shifted into a liquid state and transferred onto the substrate. An inside of the ink may be in a solid state and shifted into a liquid phase such that the ink is transferred onto the substrate. The heat supply control device may control a temperature of the substrate to allow the ink to have fluidity. The heat supply control device may control the ambient temperature of the ink to allow the ink to have fluidity.

The substrate may include a nonconductor and the ink may include a conductor such that no interaction occurs between the substrate and the ink. The ink may be patterned on the substrate in a separated pattern. The ink may include a metal compound, and the metal compound may be subject to an annealing process to remove undesired elements while retaining a desired metal element. The metal compound may be subject to the annealing process at temperature that is higher than a decomposition temperature of the metal compound and lower than a boiling point of the metal element.

A metal thin film may be formed on a surface of the tip to facilitate the absorption of ink onto the tip. Functional molecules may also be disposed on a surface of the tip to facilitate the absorption of ink onto the tip.

A patterning method utilizing dip-pen nanolithography may include preparing a substrate and preparing the ink to be patterned on the substrate. Preparing the substrate may include measuring a melting point of the ink when the ink includes a metal atom, measuring a melting point of the ink when the ink includes a metal compound, determining if the melting point of the ink is within a predetermined temperature, and selecting one of the metal atom and the metal compound as the ink.

The method may further include checking an absorption degree of the ink onto the tip. The method may further include preparing the substrate with a material identical to that of the tip and checking an absorption degree of the ink onto the tip.

Functional molecules may be disposed on the tip before the ink is absorbed onto the tip. In another instance, a metal thin film may be formed on the tip before the ink is absorbed onto the tip. When the tip is ready, the ink may be absorbed onto the tip.

Heat may be supplied to the ink to provide a surface of the ink with more fluidity to facilitate a transfer of the ink onto the substrate. When the ink includes a metal compound, the ink may be subject to an annealing process to remove undesired elements while retaining a desired metal element. The annealing process may be at a temperature that is higher than a decomposition temperature of the metal compound and lower than a boiling point of the metal element.

According to the patterning apparatus and method using dip-pen nanolithography process, a metal, e.g., gold (Au), may be directly deposited on a nonconductive substrate, e.g., silicon dioxide (SiO₂). As a result, the patterning apparatus and method may be used to directly print a circuit, repair a broken circuit, or correct defects of a photomask. Furthermore, a metal interconnection may be formed on the nonconductive substrate by using the dip-pen nanolithography process.

### BRIEF DESCRIPTION OF THE DRAWINGS

The above and/or other aspects and advantages of the disclosure may become more apparent and readily appreciated when the following description is read in conjunction with the accompanying drawings of which:

FIG. 1 is a view illustrating a configuration of dip-pen nanolithography according to example embodiments;

FIG. 2 is a view illustrating a diffusion model of ink according to example embodiments;

FIG. 3 is a view illustrating metal atoms patterned on a nonconductive substrate according to example embodiments;

FIG. 4 is a view illustrating ink absorbed onto the surface of a substrate after a solvent is volatilized in a patterning method according to example embodiments; and

FIG. 5 is a view illustrating a pattern before and after an annealing process is performed according to example embodiments.

### DETAILED DESCRIPTION

It will be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations of one or more of the associated listed items.

It will be understood that, although the terms first, second, third, etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, e.g., “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various embodiments only and is not intended to be limiting of example embodiments. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art. It will be further understood that terms, including those defined in commonly used dictionaries, should be interpreted as having a meaning that is consistent with their meaning in the context of the relevant art and will not be interpreted in an idealized or overly formal sense unless expressly so defined herein.

Hereinafter, a patterning apparatus and method using dip-pen nanolithography according to example embodiments will be described in further detail with reference to accompanying drawings.

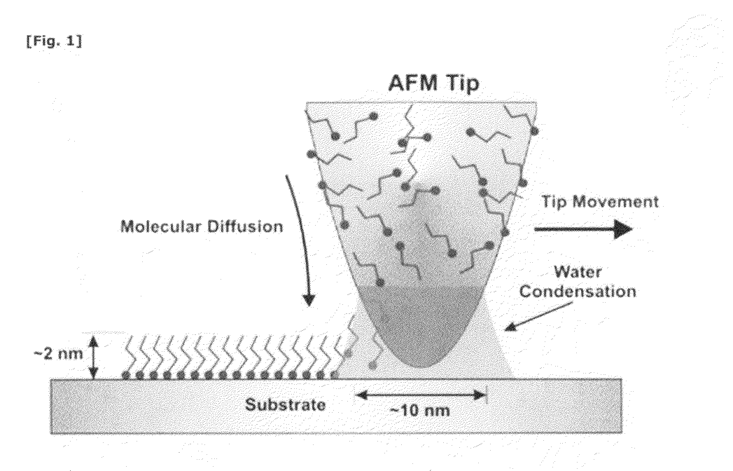

FIG. 1 is a view illustrating a configuration of dip-pen nanolithography according to example embodiments. As shown in FIG. 1, dip-pen nanolithography may involve the direct deposition of various types of molecules onto a surface of an object using an atomic force microscope tip. According to dip-pen nanolithography, a tip serving as a pen may absorb various types of molecular inks and drop the molecular inks on a substrate to form a pattern. When the tip is in relatively close proximity to or makes contact with the substrate, a capillary phenomenon may occur between the tip and the substrate. As a result, the molecular inks absorbed on the tip may diffuse onto the substrate through the capillary phenomenon. It should be understood that contact between the tip and substrate is deemed to occur if the positions of the tip and the substrate are such that the capillary phenomenon takes place.

According to the patterning apparatus, even if there is no interaction between the inks and a nonconductive substrate, the inks may still be directly deposited on the nonconductive substrate to form a pattern if certain conditions are met and the inks are sufficiently absorbed on the tip. Those certain conditions represent conditions of the inks and the tip, independent of the interaction between the inks and the nonconductive substrate.

The conditions of the inks will be described below. The inks may include conductive material. There may be no interactions occurring between the inks and the nonconductive substrate. Furthermore, the inks may include metal atoms, e.g., gold (Au). The metal atoms may correspond to a target metal patterned on the substrate.

Because metal atoms have a relatively high melting point, a metal compound having a lower melting point may be used. For instance, if the target metal is gold (Au), then chloroauric acid (HAuCl₄) may be used as the metal compound. The chloroauric acid (HAuCl₄) has a melting point lower than that of gold (Au). Thus, chloroauric acid (HAuCl₄) may be absorbed on the tip with greater ease than gold (Au). This may be described with reference to a diffusion model of ink.

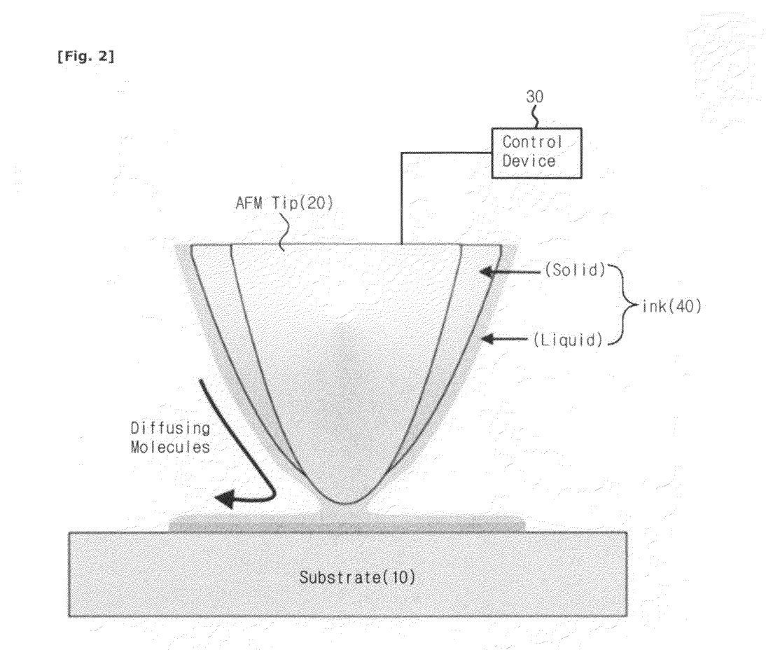

FIG. 2 is a view illustrating a diffusion model of inks according to example embodiments. As shown in FIG. 2, the inks 40 (metal atom or metal compound) may be absorbed on a tip 20. When the temperature of the tip 20 is lower than a melting point of the inks 40, the interior of the inks 40 may be in a solid state while the surface of the inks 40 may be in a liquid state. A diffusion coefficient of the inks 40 may be increased at the melting point even if the change of temperature is relatively small. Thus, the surface of the inks 40 may be shifted into a liquid phase corresponding to the level of the melting point and then diffused onto a substrate 10, such that the inks 40 may be directly deposited on the substrate 10. Stated more clearly, the inks 40 may be deposited on the substrate 10 even if there is no interaction between the inks 40 and the substrate 10 or if the interaction between the inks 40 and the substrate 10 is relatively weak.

In view of the above, it may be beneficial for the temperature of the tip 20 to be controlled to the level of the melting point of the inks 40. For instance, the temperature of the tip 20 may be set to correspond to the melting point of the inks 40. However, when the inks 40 include gold (Au), the temperature of the tip 20 may not be easily controlled to the level of the melting point of the gold (Au), because gold (Au) has a relatively high melting point. In contrast, when the inks 40 include chloroauric acid (HAuCl₄), the temperature of the tip 20 may be easily controlled to the level of the melting point of the chloroauric acid (HAuCl₄), because chloroauric acid (HAuCl₄) has a lower melting point.

When a target metal to be patterned on the substrate 10 using the above principle has a relatively high melting point, the target metal may be replaced with a compound (that contains the target metal) to reduce the melting point. The compound may be selected to contain elements having a boiling point lower than that of the target metal. The presence of the lower boiling point elements will facilitate the isolation of the target metal through an annealing process which will be described later.

The inks 40 are not limited to a metal compound. The inks 40 may be prepared in the form of metal atoms as long as the temperature of the tip 20 may be controlled to the level of the melting point of the metal atoms.

The patterning apparatus and method may include a heat supply control device 30 connected with the tip 20 to control the temperature of the tip 20. The heat supply control device 30 may include a heater and other corresponding components. The heat supply control device 30 may control the temperature of the tip 20 to the level of the melting point of the inks 40. As a result, the inks 40 may diffuse and become deposited on the substrate 10.

The heat supply control device 30 may also be connected to the substrate 10 to control the temperature of the substrate 10. Furthermore, the heat supply control device 30 may control the ambient temperature of the inks 40. Even if the heat supply control device 30 is not connected with the tip 20 or the substrate 10, heat may supplied to the ambient air to allow the surface of the inks 40 to have fluidity.

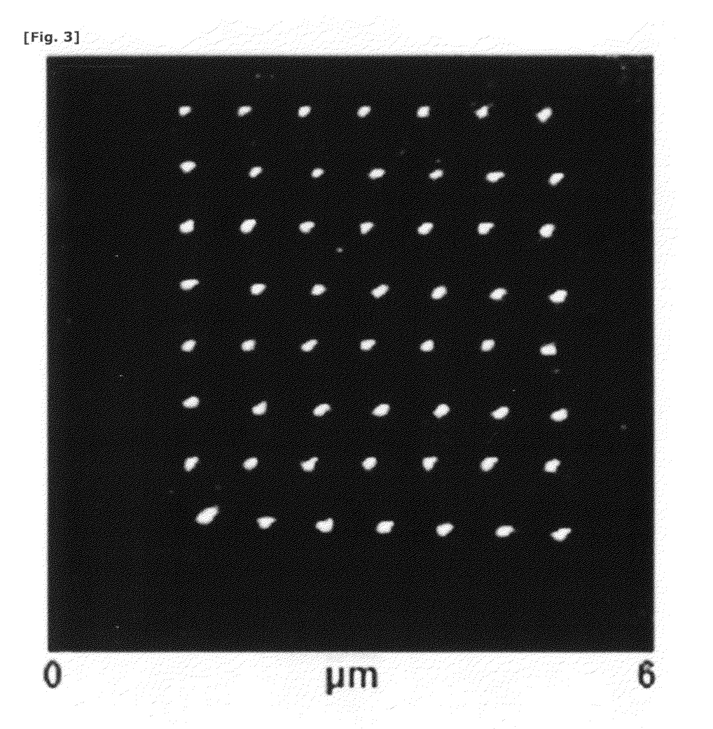

FIG. 3 is a view illustrating metal atoms patterned on a nonconductive substrate according to example embodiments. Referring to FIG. 3, the chloroauric acid (HAuCl₄) inks may be deposited and patterned on a silicon dioxide (SiO₂) substrate. The target metal to be patterned on the substrate may be gold (Au), and silicon nitride (Si₃N₄) may be used as the tip 20.

Even if there is no interconnection between the silicon dioxide (SiO₂) substrate serving as a nonconductor and the chloroauric acid (HAuCl₄) inks serving as a conductor, the inks may be patterned on the substrate in the form of a separated pattern. The term “separated pattern” means that the ink droplets are isolated from each other and independently patterned on the substrate. Inks may be patterned on a conductive substrate or a nonconductive substrate while being connected to a conductor provided on the nonconductive substrate.

Hereinafter, the process conditions of the dip-pen nanolithography capable of patterning the inks in the form of the separated pattern as shown in FIG. 3 will be described.

1. Conditions of the Inks

A melting point of the inks may be set within the temperature of the tip. The melting point of potential inks may be measured to select inks having a melting point that is set within the temperature range of the tip. Because inks prepared in the form of metal atoms typically have a relatively high melting point, inks prepared in the form of a metal compound having a lower melting point may be selected. Thus, it may be beneficial to use inks prepared in the form of a chloroauric acid (HAuCl₄) compound having a relatively low melting point instead of inks prepared in the form of metal atoms having a relatively high melting point.

When selecting a metal compound, it may be beneficial for the other elements to have a boiling point lower than that of the target metal element. The lower boiling point of the other elements may facilitate the isolation of the target metal during an annealing process. Temperature properties of elements constituting such a metal compound may be as follows.

Boiling points of other elements<Decomposition temperature of the metal compound<Melting point of the target metal element

A solvent capable of dissolving the appropriate metal compound may be selected. The solvent may dissolve the metal compound such that the metal compound may be absorbed onto the tip. For instance, the tip may be immersed in the dissolved metal compound so the metal compound is absorbed onto the tip.

2. Conditions of the Tip

It may be determined whether the melting point of the inks has been set within the temperature of the tip. The melting point of the ink has been discussed above in connection with the conditions of the ink.

It may be determined whether the inks have been absorbed onto the tip. Because the tip has a relatively small size of about several μm, the absorption degree of the ink may not be easily recognized. Thus, the absorption degree of the inks may be determined by replacing the tip with a substrate having a surface formed of a material that is identical to that of the tip.

When an interaction is weak or absent between the inks and the tip, the inks may not be easily absorbed onto the tip. In such a case, functional molecules may be disposed on the surface of the tip or a metal thin film may be formed thereon to facilitate the absorption of the inks onto the surface of the tip. For instance, when a chloroauric acid (HAuCl₄) aqueous solution containing a metal compound is used as the ink, the chloroauric acid (HAuCl₄) aqueous solution may not be easily absorbed onto the hydrophobic silicon nitride (Si₃N₄) tip. In this situation, a gold (Au) thin film containing the same element as that of the inks may be deposited on the silicon nitride (Si₃N₄) tip. The metal thin film may be deposited using various methods including thermal evaporation, electron beam, chemical evaporation, and other suitable processes. After the inks have been coated on the tip, the solvent may be volatilized so that only the metal compound remains on the tip. To volatilize the solvent, the tip may be dried.

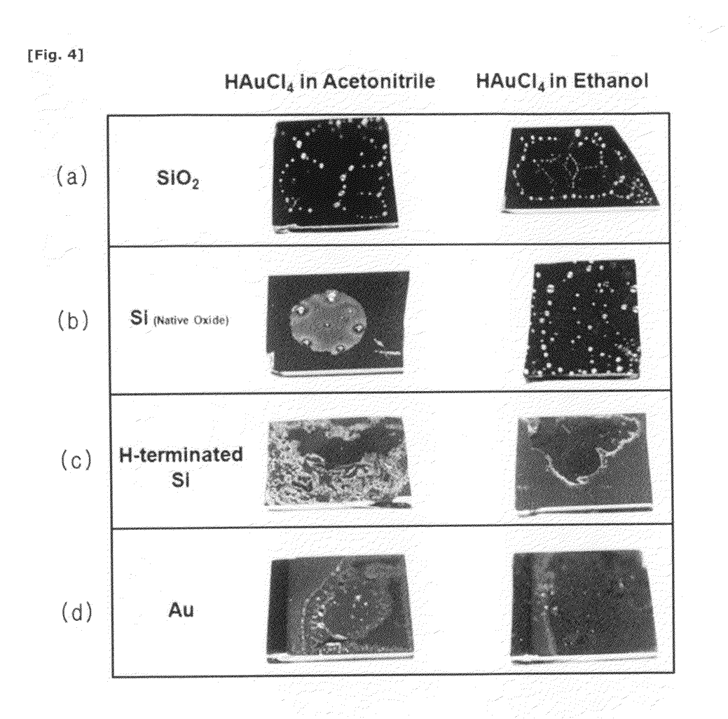

FIG. 4 is a view illustrating inks absorbed on the surface of a substrate after the solvent is volatilized in the patterning method according to example embodiments. As illustrated in FIG. 4, the absorption degree of the ink may be determined from the substrate having the surface coated with a material identical to that of the tip. Acetonitrile and ethanol may be used as the solvent.

In the case of chloroauric acid (HAuCl₄) inks, an affinity between the inks and a normal nonconductive substrate may be relatively poor, as illustrated in FIGS. 4A and 4B. Thus, the surface of the substrate may be treated with fluorine as illustrated in FIG. 4C or a gold (Au) thin film may be formed on the surface of the substrate as illustrated in FIG. 4D, so that the affinity may be improved. The surface of the substrate may be coated with material identical to that of the tip.

As described above, a pattern may be formed on a substrate with a dip-pen nanolithography process if the inks and the tip satisfy the above conditions. Referring to FIG. 3, the chloroauric acid (HAuCl₄) inks may be patterned on the silicon dioxide (SiO₂) substrate even if there is no interaction between the chloroauric acid (HAuCl₄) inks and the silicon dioxide (SiO₂).

Furthermore, when the inks are prepared in the form of a metal compound, only the target metal atom may be selectively retained in the final formed pattern while the other elements may be removed. Because boiling points of the elements constituting the metal compound are different from each other, only the desired metal element may be left by removing the undesired elements through an annealing process.

3. Annealing Conditions

The decomposition temperature of the metal compound may be determined. The annealing process may be performed at a temperature higher than the decomposition temperature of the metal compound and lower than the boiling point of the target metal element. As a result, when the metal compound is subject to the annealing process at the temperature higher than the decomposition temperature and lower than the boiling point of the target metal element, the metal compound may decompose into individual elements and the undesired elements with the lower boiling point will vaporize, thus leaving the target metal element. Because of the higher boiling point of the target metal element, only the target metal element will remain.

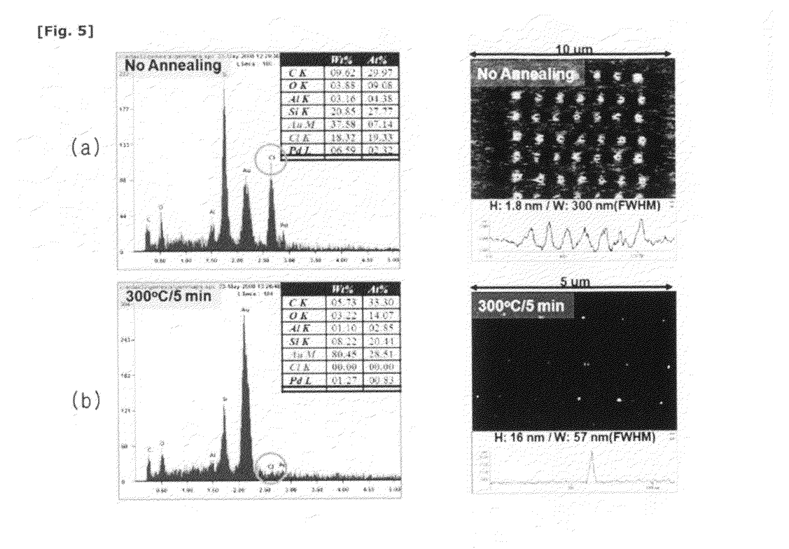

FIG. 5 is a view illustrating a pattern before and after the annealing process is performed according to example embodiments. FIG. 5A illustrates the composition ratios and line widths of materials before the annealing process is performed. FIG. 5B illustrates the composition ratios and line widths of the materials after the annealing process has been performed. Referring to FIG. 5, if the chloroauric acid (HAuCl₄) is subjected to a temperature of about 300° C. or more, which is higher than the decomposition temperature of the chloroauric acid (HAuCl₄), then hydrogen (H) and chlorine (Cl) may be completely removed by virtue of their lower boiling points so that a pure gold (Au) pattern may be obtained. Furthermore, a minimum line width of the pattern may be ensured through an additional effect of the annealing.

Hereinafter, a pattering operation using the dip-pen nanolithography process will be described with reference to FIGS. 1 to 5. A pattering apparatus using the dip-pen nanolithography process may include the substrate 10, the tip 20 that comes in proximity to or makes contact with the substrate 10, and the heat supply control device 30 that controls the temperature of the tip 20.

Because the tip 20 sufficiently absorbs the inks 40, if the heat supply control device 30 controls the temperature of the tip 20 to be lower than the melting point of the inks 40, the surface of the inks 40 may be shifted into a liquid phase and is then diffused onto the substrate 10 as illustrated in FIG. 2. Thus, the inks 40 are deposited on the substrate 10. The inside of the inks 40 may be in a solid state. The solid-state ink may be shifted into a liquid-state ink so that the solid-state ink may serve as a source of the inks 40 that is diffused onto the substrate 10.

To deposit the ink onto the substrate by liquifying the surface of the inks 40, the melting point of the inks 40 has to be within the temperature of the tip 20. Conditions of the inks 40 may be as described above. The melting point of the inks 40 prepared in the form of a metal atom may be measured to determine if the melting point is within the temperature of the tip 20. If the melting point of the inks 40 is not within the temperature of the tip 20, then the inks 40 may be prepared in the form of a metal compound. The boiling points of the undesired elements should be lower than that of the target metal element and lower than the decomposition temperature of the metal compound. For instance, chloroauric acid (HAuCl₄) inks 40 prepared in the form of a metal compound may be patterned on the silicon dioxide (SiO₂) substrate 10 by depositing the chloroauric acid (HAuCl₄) inks 40 on the silicon dioxide (SiO₂) substrate 10 as illustrated in FIG. 3. In such a case, even if the interaction is relatively weak or absent between the chloroauric acid (HAuCl₄) inks 40 and the silicon dioxide (SiO₂) substrate 10, the inks 40 may still be patterned on the silicon dioxide (SiO₂) substrate 10.

The silicon dioxide (SiO₂) substrate 10 may be subject to an annealing process so that only the target metal element is left while the other undesired elements are removed. For instance, the target metal element gold (Au) may be selectively retained while the element chlorine (Cl) may be removed as illustrated in FIG. 5. As a result, the gold (Au) may be patterned on the substrate 10 regardless of the interaction between the inks 40 and the substrate 10.

While example embodiments have been disclosed herein, it should be understood that other variations may be possible. Such variations are not to be regarded as a departure from the spirit and scope of example embodiments of the present application, and all such modifications as would be obvious to one skilled in the art are intended to be included within the scope of the following claims.

1. A patterning apparatus utilizing dip-pen nanolithography, comprising:
a substrate;
a tip configured to be arranged in proximity or in contact with the substrate;
an ink covering the tip, the ink being formed of a material having a liquid state; and
a heat supply control device configured to convert the ink into the liquid state so as to facilitate a transfer of the ink onto the substrate by capillary action.

2. The patterning apparatus of claim 1, wherein the heat supply control device is configured to control a temperature of the ink to a level that is at or above a melting point of the ink.

3. The patterning apparatus of claim 1, wherein the heat supply control device is configured to control a temperature of the tip to a first level that is lower than a melting point of the ink.

4. The patterning apparatus of claim 3, wherein the heat supply control device is configured to increase the first level to a second level so as to convert the ink into a liquid state when the ink is to be transferred onto the substrate.

5. The patterning apparatus of claim 4, wherein the heat supply control device is configured to convert an interior of the ink from a solid state to the liquid state.

6. The patterning apparatus of claim 1, wherein the heat supply control device is configured to control a temperature of the substrate so as to provide the ink with fluidity.

7. The patterning apparatus of claim 1, wherein the heat supply control device is configured to control a temperature of the ink so as to provide the ink with fluidity.

8. The patterning apparatus of claim 1, wherein the substrate includes a nonconductor and the ink includes a conductor such that no interaction occurs between the substrate and the ink.

9. The patterning apparatus of claim 8, wherein the tip is configured to transfer the ink onto the substrate in a separated pattern.

10. The patterning apparatus of claim 1, wherein the ink includes a metal compound having a metal element, the metal compound being such that undesired elements can be removed with an annealing process while retaining the metal element.

11. The patterning apparatus of claim 10, wherein the annealing process involves an annealing temperature that is higher than a decomposition temperature of the metal compound and lower than a boiling point of the metal element.

12. The patterning apparatus of claim 1, further comprising:
a metal thin film on a surface of the tip to facilitate an absorption of the ink onto the tip.

13. The patterning apparatus of claim 1, further comprising:
functional molecules on a surface of the tip to facilitate an absorption of the ink onto the tip.

14. A patterning method utilizing dip-pen nanolithography, comprising:
preparing a substrate;
preparing a tip configured to be arranged in proximity or in contact with the substrate;
measuring a melting point of an ink when the ink includes a metal atom;
measuring the melting point of the ink when the ink includes a metal compound;
determining if the melting point of the ink is within a predetermined temperature range;
selecting one of the metal atom and the metal compound as the ink; and
preparing the ink to be patterned on the substrate.

15. The patterning method of claim 14, further comprising:
determining an absorption degree of the ink onto the tip.

16. The patterning method of claim 15, wherein the determining the absorption degree of the ink onto the tip comprises preparing an additional substrate including material identical to material of the tip and determining the absorption degree of the ink onto the additional substrate.

17. The patterning method of claim 15, wherein preparing the tip includes absorbing functional molecules on the tip before the ink is absorbed onto the tip.

18. The patterning method of claim 15, wherein preparing the tip includes forming a metal thin film on the tip before the ink is absorbed onto the tip.

19. The patterning method of claim 15, further comprising:
absorbing the ink onto the tip.

20. The patterning method of claim 19, further comprising:
supplying heat to increase fluidity of the ink so as to facilitate a transfer of the ink onto the substrate.
